(19) United States
(12) Patent Application Publication
(10) Pub. No.: US 2009/0119365 A1
(43) Pub. Date: May 7, 2009

(54) Method and apparatus for display synchronization using image compression

(75) Inventor: Ratko V. Tomic, Lexington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: 1st WORKS CORPORATION, Norfolk, MA (US)

(21) Appl. No.: 12/288,448

(22) Filed: Oct. 20, 2008

Related U.S. Application Data
(60) Provisional application No. 60/983,672, filed on Oct. 30, 2007.

(51) Int. Cl. G06F 15/16

(52) U.S. Cl. 709/203

(57) ABSTRACT

Methods and apparatuses for synchronizing displays of a local and a remote device using image compression to achieve efficiency gains are disclosed. A local device requests an update for a particular requested region of a remote device's display, receives an update region which is a portion of the requested region, and updates a stored local representation of the remote display based on the update region. A remote device compares, upon a request from a local device for an update, portions of the old and new stored images corresponding to the requested region. Compared pixels are then encoded to yield an update region and transmitted to the local device. In the encoding, pixels which changed between the old image and the new image are encoded opaque and with the color corresponding to the pixels in the new image, and at least one pixel which did not change between the old image and the new image is encoded transparent.

### RELATED APPLICATION

This application claims the benefit of U.S. Provisional Application No. 60/983,672, filed on Oct. 30, 2007. The entire teachings of the above application are incorporated herein by reference.

### BACKGROUND

Computer networks such as the Internet enable services that synchronize the states of connected devices. One such service is remote display, which enables one device (a local device) to maintain on its display a portion of the display of another (remote) device. With such a service, the user of a local device may view the displayed content of a remote device and perform operations at the remote device by means of the network connection between the two devices (e.g., by transmitting commands to the remote device).

One challenge with remote display services pertains to efficiently synchronizing a local display with a remote display. In order to provide the local device user with a seamless experience, a remote display system must synchronize (update) the local display with the contents of the remote display frequently. If the local display is not updated quickly enough, the local display user may experience lag at the local display. This may result in the local device user performing operations based on a stale version of the remote display, causing unintended results.

Transmitting the entire remote display to the local device at short intervals is demanding in terms of resources, e.g., network bandwidth and processor usage at the local and remote ends, and generally is not feasible. If the size of the local display is smaller than the size of the remote display, it is known in the art to update only a subset of the remote display, e.g., the subset that the user of the local device is currently viewing. More efficient ways to perform display synchronization that take advantage of particular display or device characteristics and particular image formatting and compression schemes are continually sought.

### SUMMARY

The present invention addresses the foregoing need for more efficient display synchronization techniques.

An embodiment of the invention includes a remote device storing an old image and a new image, the old image comprising the last version of the remote device's display that was transmitted to a local device requesting an update of a particular requested region and the new image comprising the content of the old image and additionally updates for the requested region. The method also includes the remote device comparing, upon a request from the local device for an update for the requested region, portions of the old and new images corresponding to the requested region. The method further includes encoding compared pixels to yield an update region and transmitting the update region to the local device. In the encoding, (i) pixels which changed between the old image and the new image are encoded opaque and with the color corresponding to the pixels in the new image, and (ii) at least one pixel which did not change between the old image and the new image is encoded transparent. An embodiment of the invention further includes stripping boundary pixels that are unchanged between the old and new images. In an embodiment of the invention, unchanged pixels are assigned a color that does not interfere with the visual appearance of the pixels.

Another embodiment of the invention includes a local device requesting an update for a particular requested region of a remote display. The method further includes receiving an update region which is a portion of the requested region and updating a stored local representation of the remote display based on the update region. In an embodiment of the invention, the method further includes refreshing the local device's display based on the updated local representation. Other embodiments of the invention prioritize certain regions of the local representation for update, such as by proceeding in concentric layers outward from the currently viewed rectangle on the local device's display. Other embodiments of the invention use a Javascript-enabled browser to interface with and display the local representation.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an overview of an example of the display synchronization process of the present invention, including components associated with the local and remote devices and messages transmitted between the devices.

FIG. 2 shows steps performed by a local device and a remote device to support display synchronization as in an embodiment of the present invention.

FIG. 3 shows a technique for prioritizing regions for synchronization at the local device.

FIG. 4 shows a technique for using Javascript at the local device to support synchronization of the local display with the remote display.

FIG. 5 shows a technique for encoding, at the remote device, changed pixels in the remote display differently than unchanged pixels.

FIG. 6 is a flow diagram showing a first technique for encoding unchanged pixels of the remote display.

FIG. 7 is a flow diagram showing a second technique for encoding unchanged pixels of the remote display.

FIG. 8 shows a technique of encoding unchanged pixels as opaque instead of transparent if they are part of a sequence of unchanged pixels shorter than a specified length.

FIG. 9 shows a high-level block diagram of an exemplary configuration for the local and remote devices.

### DETAILED DESCRIPTION

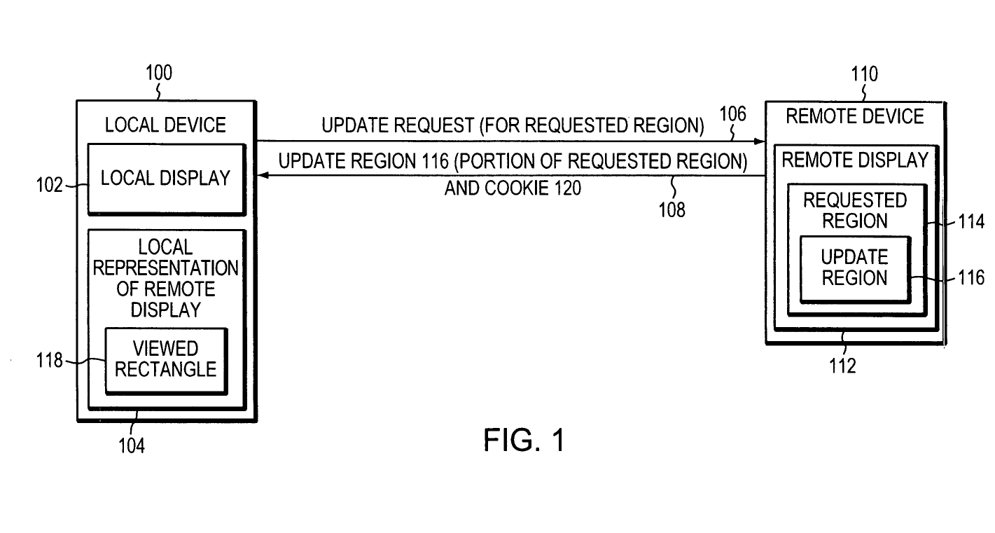

Referring to FIG. 1, display synchronization (also termed refreshing or updating) as in the present invention involves a local device 100, including a local display 102, and a remote device 110, including a remote display 112. Each display comprises a set of pixels (typically a rectangular region) which forms, at any instant, an image that is presented to the user. The local device 100 includes a local representation 104 of the remote display, which contains the last known contents (i.e., contents as of the last synchronization) of the remote display 112. The local representation 104, stored at the local device 100, is logically the same size (i.e., same pixel dimensions) as the remote display 112. A portion of the local representation 104 is shown on the local display 102 and is known as the viewed rectangle 118. Local display 102 and viewed rectangle 118 represent the same pixel dimensions and content.

In some cases, the user of the local device 100 may see at any given time a subset of the remote display 112. As the user of the local device 100 scrolls (using any conventional method of scrolling) the local display 102, the local display 102 is painted (drawn) with corresponding portions of the local representation 104. In this way, the user of the local device 100 may remotely navigate the remote display 112.

In order to synchronize the local display 102 with the remote display 112 (i.e., update the local representation 104 and refresh the local display 102 accordingly with the up-to-date viewed rectangle 118), messages are sent between the local device 100 and the remote device 110. First, an update request message 106 is sent to the remote device 110. This update request message 106 specifies a particular region, (termed a requested region 114) that is to be updated at the local device 100 (more precisely, at the local representation 104). The requested region 114 need not correspond to what is currently displayed on the local display 102, i.e., to the viewed rectangle 118. That is, the local device 100 may desire to update the local representation 104 with an arbitrary portion of the remote display 112, which may be a portion of the remote display 112 that the user of the local device 100 is not currently viewing on the local display 102 (i.e., which is not the viewed rectangle 118).

In an embodiment of the invention, the requested regions 114 are encoded within the URL used for the Image.src requesting the image. In order to avoid browser or proxy servers caching the request which might have the same URL as some earlier request, a unique sequence number is appended at the tail end of each image request URL. This unique sequence number is created initially from the time-date value (Javascript time in milliseconds since Jan. 1, 1970), which is then incremented on each request. Hence no two requests have the same URL, preventing the cache from returning a stale image.

In response to the update request message 106, the local device receives an update message 108 containing update information. The update message 108 includes data for a portion of the requested region 114, i.e., for an update region 116 which is a subset of the requested region 114. That is, the local device 100 may receive an update for a smaller region than the region for which an update was requested. By only sending back to the local device 114 an update of a portion of the requested region, the present invention is more efficient than conventional display synchronization systems.

In an embodiment of the invention, the update message 108 includes a cookie 120 containing additional information that is used by the local device 100 to synchronize its display. This additional information specifies the nature of the update region 116, which is important since the update region 116 may differ from the requested region 114. In embodiments of the invention, the requested region and the update region need not be rectangular.

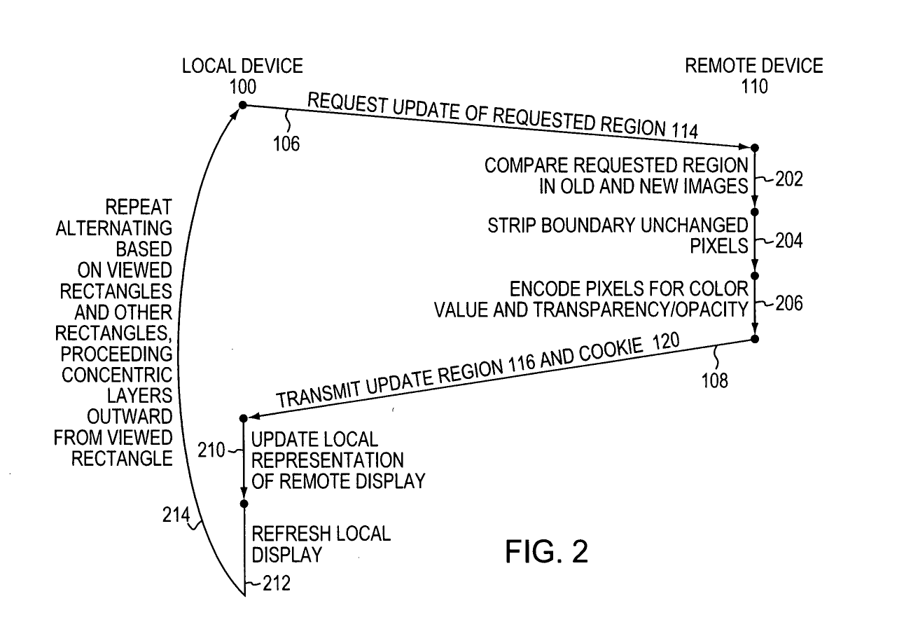

FIG. 2 shows steps performed by the local device 100 and the remote device 110 in support of display synchronization as in an embodiment of the invention. As described above, the local device 100 requests, at 106, an update of a requested region 114. The remote device 110 then performs the following steps:

1) compare (in the sense of color value of pixels), at step 202, the requested region 114 in old and new images stored at the remote device;

2) optionally strip from the compared region, at step 204, boundary pixels which did not change between the old and new images; and

3) encode, at step 206, compared pixels according to color and transparency/opacity (if the optional stripping step above is performed, the encoding will be performed on the region resulting from the stripping step).

These steps 202, 204, and 206 are described in further detail herein.

After the remote device 110 performs these steps, it transmits an update region 116 and optionally a cookie 120 to the local device 100, as described above. With the update region 116 and optionally the cookie 120, the local device 100 updates, at step 210, the local representation 104 and refreshes, at step 212, the local display 102.

In an embodiment of the invention, the foregoing steps are repeated as shown at 214, for different request regions 114, alternately based on: i) the viewed rectangle 118; and ii) other regions of the local representation 104. In this way, priority is given to synchronizing the viewed rectangle 118 (since it is processed during every other synchronization iteration), resulting in a better experience for the user of the local device 100. In other embodiments, different update schedules are used, e.g., updating the viewed rectangle every third iteration instead of every other iteration.

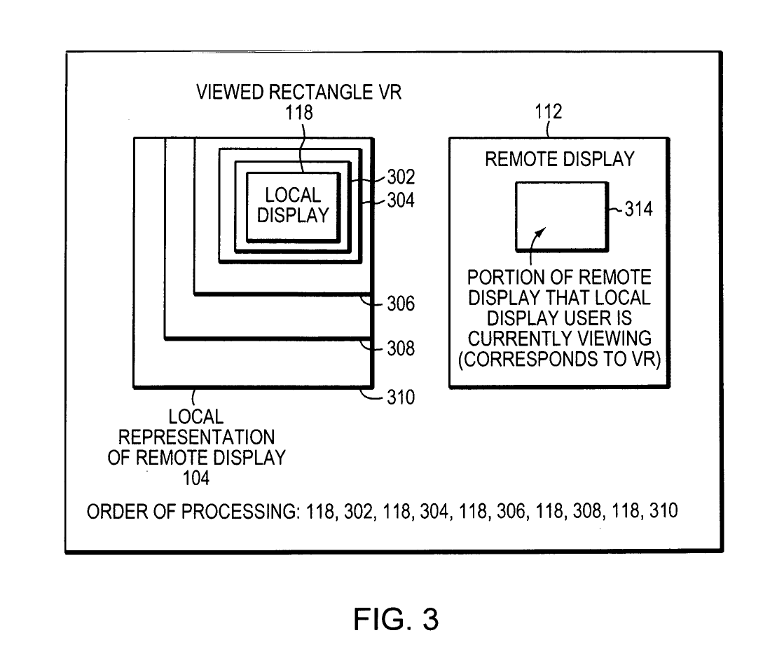

In an embodiment of the invention, the process of synchronizing regions other than the viewed rectangle 118 as described above proceeds in concentric layers outward from the viewed rectangle 118, until the entire local representation 104 is updated. In the illustrative example of FIG. 3, updating may proceed as follows: viewed rectangle (VR) 118, region 302, VR 118, region 304, VR 118, region 306, VR 118, region 308, VR 118, region 310, where (302, 304, 306, 308, 310) are each a subset of the next and 310 corresponds to the entire local representation 104. The portion of the remote display 112 corresponding to the viewed rectangle 118 is shown at 314 in FIG. 3. Each time the user scrolls the local display, moving the location of the viewed rectangle 118 within the context of the local representation 104, the process of updating begins anew. That is, the process of alternately updating the viewed rectangle 118 and other regions begins anew with the new viewed rectangle 118. In this way, regions closest to the viewed rectangle 118 are given priority for updating, so that when the user scrolls the local display 102, up-to-date content of the remote display 112 is likely to be available for immediate display on the local display 102 without the need for an update.

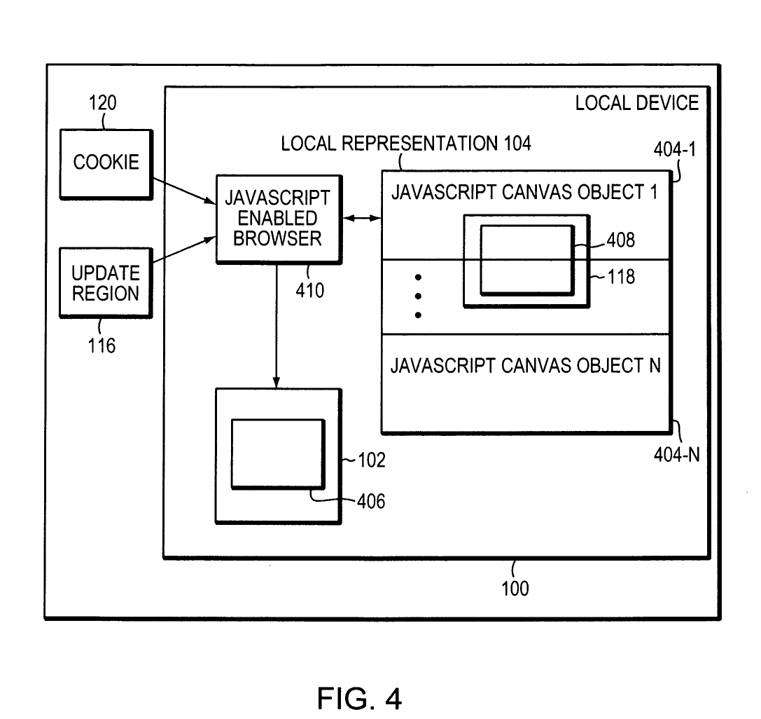

Referring to FIG. 4, in an embodiment of the invention, the local display 102 is updated using the update region 116 and cookie 120. Javascript Canvas objects 404-1, . . . , 404-N are used to store in a computer-readable medium the local representation 104. Since the maximum size of a Canvas object is 2 MB and the maximum size of a PNG (Portable Network Graphics format) image on an iPhone (for example) is 2 MB, it may be necessary to tile Canvas objects to logically represent the entire remote display. The viewed rectangle 118 may span Canvas object boundaries. The update region 116 is used to update the local representation 104, as shown at 408. That is, the local representation 104 is modified with the update region 116 at that portion 408.

A browser 410 is used to refresh the local display 102 with the update region 116, as shown at 406. In an embodiment of the invention, a Javascript-enabled browser 410 provides the interface to the Canvas objects 404-1, . . . , 404-N (i.e., uses the Canvas objects as a drawing surface). FIG. 4 shows that the browser 410 uses the local representation 104 to refresh the display 102 with the update region 116, as shown at 406. Region 406 corresponds to region 408 in the local representation 104, and the local display 102 corresponds to the viewed rectangle 118.

In the example in FIG. 4, the update region 116 (corresponding to 408 in the local representation or 406 in the local display) is a subset of the new viewed rectangle 118 (or the local display 102). This may occur if, for example, the local device 100 specified a request region 114 that is a superset of viewed rectangle 118 but the only pixels within the request region 114 that changed since the last synchronization are within the smaller update region 116. Alternatively, this may occur if the requested region 114 is a subset of the viewed rectangle 118. It is also possible for the update region 116 to not be a subset of the viewed rectangle 118, which would result in a different configuration than FIG. 4.

FIG. 4 also shows that in an embodiment of the invention, the local device 100 receives a cookie 120 which is used by the browser 410 to update the local representation 104 and refresh the local display 102. Since HTML/Javascript loading of images via the “IMG src” HTML tag does not transmit any other side information along with the image data, except for the image dimensions, cookie is used to specify which sub-rectangle (i.e., which update region 116) of the originally specified request region 114 is received by the local device 100. In particular, two coordinates (e.g., x, y) are needed to specify the position of the upper left corner of the reduced update rectangle (i.e., update region 116) within the requested rectangle (i.e., request region 114), and a cookie is used to encode this extra information. In an alternative embodiment, the coordinates may specify the location of the update region 116 relative to the full display area.

A session cookie is optimal, although any cookie type may be used. A session cookie expires when the browser 410 leaves the desktop session site, whereas other cookies persist in the browser storage after the browser goes to another site. Upon receiving the update region 114, Javascript compares the cookie 120 with the original request (the request and the cookie name carry the same sequence number) and paints the sub-rectangle (update region 116) specified by the cookie 120 instead of the request region 114.

The encoding of two numbers x,y into the cookie can be done using two strings, requiring two terminator characters, one for each number. To reduce the average number of characters sent, in the preferred approach, the two numbers x, y are combined into a single number n using the following formula:

if (x>y) n=x*x+y

if (x<=y) n=y*y+y+x

A decoder at the browser receives a number n, which it decomposes into x, y as follows:

| r = floor(sqrt(n)); // r=integer square root of n | |
|---|---|
| d = n − r*r; | // d=excess from integer square |

| if (d<r) {x=r; y=d;} | |
|---|---|
| else | {y=r; x=d−r;} |

There are other similar ways to encode x, y (or any sequence of integers) into a single number, reducing the average number of terminating characters. The general method for such reductions is via enumerative coding (which includes the method specified above).

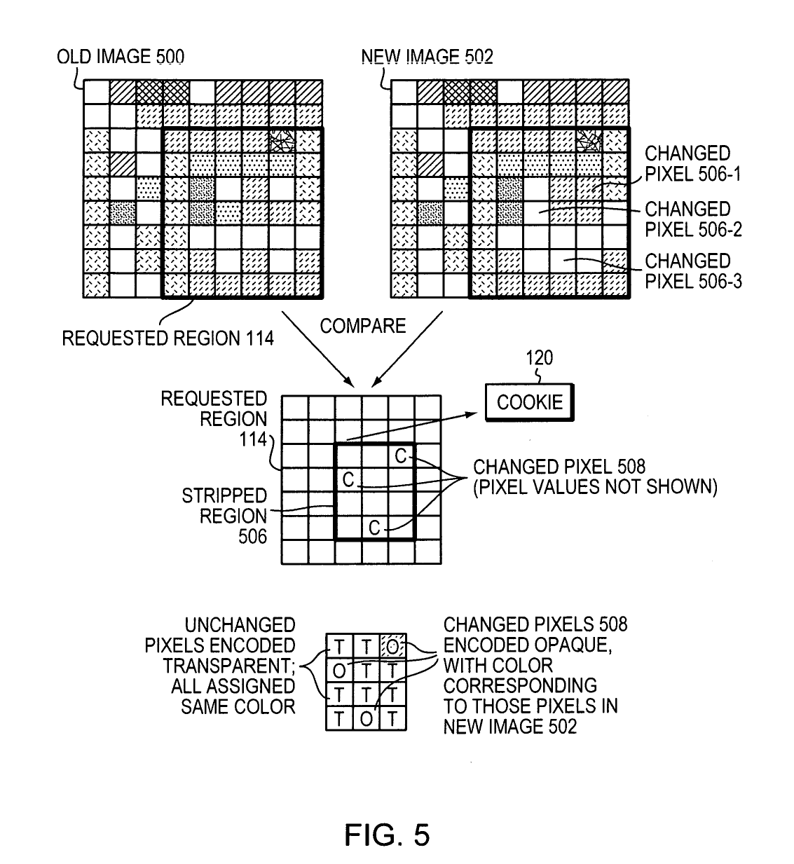

FIG. 5 shows detailed examples of the compare, strip, and encode steps performed at the remote device as in steps 202, 204, and 206, respectively, of FIG. 2. The remote device 110 stores two images: (1) an old image 500, which is a copy of the image that the local device 100 has at its local representation 104; and (2) a new image 502, which is the more recent screen content on the remote display 112 at the time of an update request message 106. The new image 502 is kept up to date with the real remote display 112 only in the areas requested by the local device 100 (i.e., only for the requested region 114). Upon receiving an update request message 106, the remote device accesses display content for the region of the remote display 112 corresponding to the requested region 114 via the Windows Mirror Driver module, in order to update the new image 502. Alternatively, software hooks via GD132 and USER32 are possible for this purpose, although they are less accurate.

The remote device 110 then compares a portion of the old image 500 corresponding to the requested region 114 with a portion of the new image 502 corresponding to the requested region 114. In the example shown in FIG. 5, three pixels (506-1, 506-2, and 506-3) changed between the old image 500 and new image 502, and the other pixels did not change. The changed pixels are collectively denoted 508 in FIG. 5.

In an embodiment of the invention, unchanged pixels are stripped from this region of comparison to yield a stripped region 506 with at least one changed pixel 508 on each boundary edge row or column. For example, as shown in FIG. 5, the top edge of the stripped region 506 is defined by the row containing changed pixel 506-1, the left edge is defined by pixel 506-2, the bottom edge is defined by pixel 506-3, and the right edge is defined by pixel 506-1. Therefore, as seen, pixels outside of the stripped region have been stripped. This promotes efficiency, as it is not necessary to transmit to the local device 100 pixels outside of the stripped region (because they did not change since the last synchronization). This minimizes the size of the image transmitted to the local device 100 as well as the amount and duration of drawing performed by the browser 410.

In an encoding step, unchanged pixels are encoded as transparent and assigned a common color value, and changed pixels are encoded as opaque, with color values corresponding to the color values of those changed pixels in the new image 502. The motivation for this encoding is twofold. First, setting all unchanged pixels to a common color increases efficiency in image compression, since it is efficient to encode a string of pixels all having same value. Secondly, setting unchanged pixels to transparent ensures that changing their color values to a common color (different than their corresponding color values in the new image 502) will not degrade the image that will ultimately be displayed in the local display 102 (since their previous color values will be visible, due to the pixels' transparency). Using transparency in this fashion during the encoding process results in greater compression and efficiency than is possible with conventional display synchronization systems.

The method of implementing transparency in the encoding may vary based on the image format used. The PNG specification allows two ways to indicate transparency: pixel by pixel (via a separate bitmap called “Alpha Channel”) or for a single RGB code value (via ancillary data known as a global tRNS chunk). For image formats which do not support transparency, such as JPEG and GIF, a transparency bitmap can be transmitted as a separate bitmap of the same dimensions as the original image, using one bit per pixel, e.g., 1=opaque, 0=transparent. Alternatively, an unused pixel value can be reserved as the “transparent pixel” and embedded into the color image. The latter method is generally more efficient since it retains more of the inter-row redundancy (useful for dictionary based compression such as the Lempel-Ziv family of algorithms, which includes gzip, zip, and deflate).

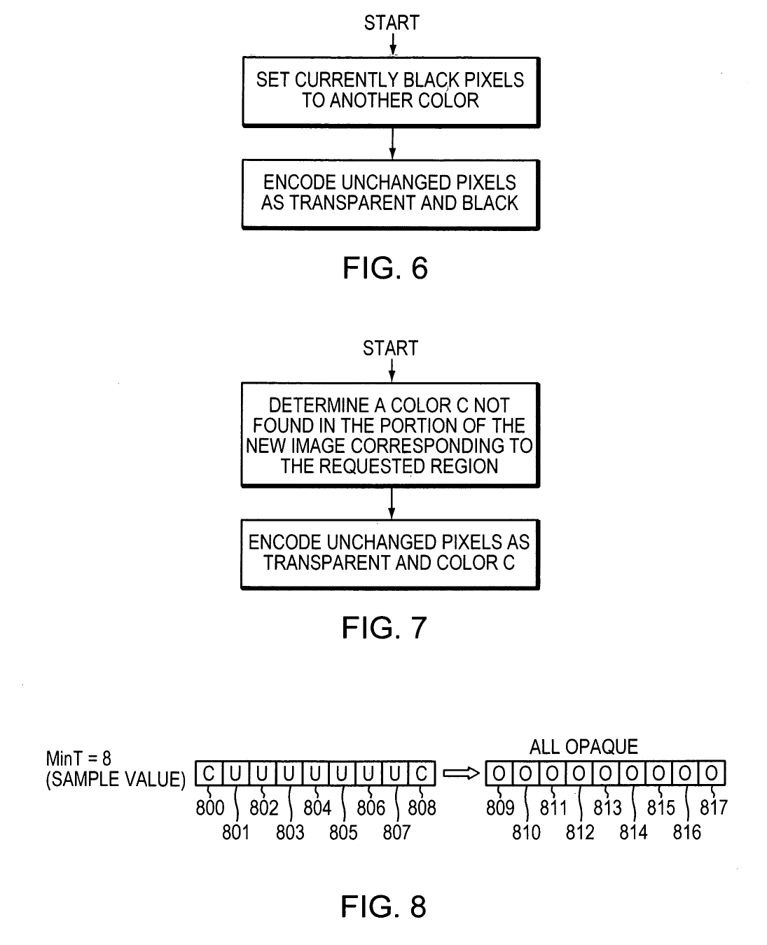

FIG. 6 shows approach for encoding the color of unchanged pixels. This encoding method approximates upfront a single pixel value in the darkest region, where the human eye cannot readily distinguish difference between colors. For the approximation, an embodiment of the present invention uses black (RGB=0,0,0) for the transparent code value and changes real black pixels to (0,0,1). However, this can be done the other way around, e.g., using (0,0,1) for the transparent code and (0,0,0) to encode the real (0,0,1) pixel. Alternative embodiments may use color values slightly different from (0,0,1), as long as they are dark enough as to be visually indistinguishable from black.

FIG. 7 shows another approach for encoding the color of unchanged pixels. In this encoding method, the portion of the new image corresponding to the requested region is examined to identify an unused RGB (color) value. Then, unchanged pixels are set to this color value. The approximate method of FIG. 6 is in practice visually indistinguishable from the encoding method of FIG. 7, provided the approximation is done within the darkest region (i.e., using colors similar to black). The method of FIG. 7 is a brute force technique which requires more computational resources than the approximate method.

An embodiment of the invention comprises PNG “filtering” (or similar functionality with other image formats such as JPEG) as part of the encoding process at the remote device. This technique codes pixels relative to those above and to the left, resulting in increased encoding efficiency.

An embodiment of the invention comprises PNG “interlacing” (or similar functionality with other image formats such as JPG) to progressively update the local representation from coarser detail to finer detail. Progressive image download and drawing results in faster perceived response for the user of the local device.

The partially transparent update region resulting from the encoding described above is compressed prior to transmission to the local device. This compression, which is different from the compression inherent in encoding an image according to an image format (e.g., PNG or JPEG) as described above, may use any standard compression technique, such as “deflate” or “gzip”. The choice of compression technique may depend on capabilities declared by the browser 410 at the local device 100. If “deflate” is used, the update region will be transmitted via HTTP using “Content-Encoding: deflate” in the HTTP response field. If the “deflate” (or other compression) action does not reduce the size of the update region (e.g., reduce the size of the PNG file containing the update region), the non-deflated (non-compressed) copy is transmitted instead.

In order to improve compression performance, an embodiment of the invention incorporates the following rule. Unchanged pixels that are part of a sequence of unchanged pixels (i.e., pixels that did not change from the old image to the new image) shorter than a specified length (labeled MinT) are encoded as opaque instead of transparent. In the example shown in FIG. 8, MinT=8, and unchanged pixels 801, . . . , 807 are surrounded by changed pixels 800 and 808. Since these seven unchanged pixels are a sequence of unchanged pixels shorter than MinT, all of these pixels are encoded as opaque, as shown at 809, . . . , 817. This technique improves compression by allowing for greater reuse of previously seen pixel sequences. That is, this technique avoids the use of numerous short, slightly differing pixel sequences (which may result in inefficient coding in a dictionary-based compression process that keeps track of previously seen sequences). Values of MinT ranging from 8 to 32 have been found to improve compression for the dictionary-based “deflate” algorithm.

Alternative embodiments use proxy components to perform the steps described above as being performed at the local device 100 and at the remote device 110. For example, instead of the local device 100 transmitting update request messages 106 directly to the remote device 110, a proxy may serve as an intermediate node. As other examples, the local representation 104 may be stored externally from the local device 100 for storage resource reasons, or the encoding may occur externally from the remote device for processor resource reasons. It is understood that the actions of the present invention occur at local or remote ends of a network connection.

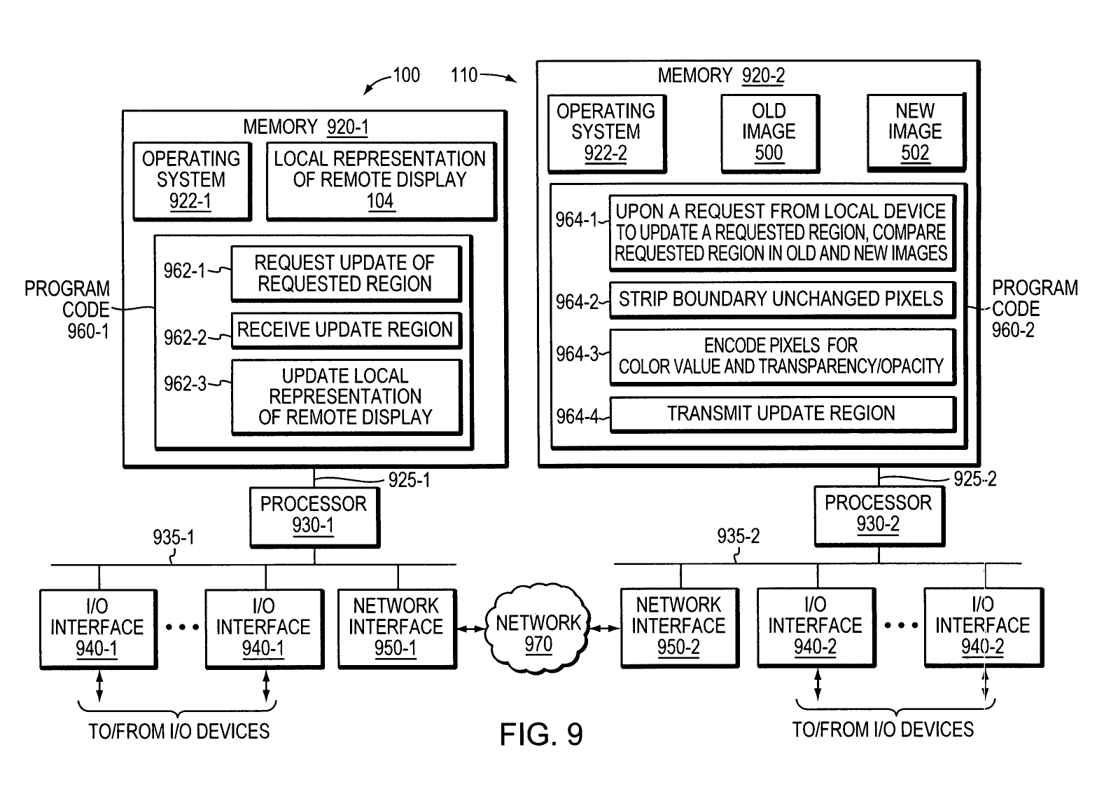

FIG. 9 is a high-level block diagram of an exemplary configuration for local device 100 and remote device 110 that may be used with the present invention. Local device 100 comprises a memory 920-1, a processor 930-1, one or more input/output (I/O) interfaces 940-1 and a network interface 950-1. The memory 920-1 is coupled to the processor 930-1 via a memory bus 925-1 which enables data to be transferred between the memory 920-1 and the processor 930-1. The processor 930-1 is further coupled to the I/O interfaces 940-1 and the network interface 950-1 via an I/O bus 935-1 which enables data to be transferred between the processor and these interfaces 940-1, 950-1.

The processor 930-1 is a conventional central processing unit (CPU) configured to execute computer-executable instructions and manipulate data contained in memory 920-1, including instructions and data that implement aspects of the present invention. In particular, memory 920-1 includes a stored local representation of the remote display 104. Memory 920-1 also includes program code (instructions) 960-1 for: 1) requesting an update of a requested region (962-1); 2) receiving an update region (962-2); and 3) updating the local representation (962-3).

The I/O interfaces 940-1 comprise circuitry that may interface the local device 100 with various I/O devices (not shown), such as display units (including local display 102), keyboards, disk units and the like.

The network interface 950-1 comprises circuitry configured to implement a conventional network interface that enables data (e.g., packets) to be transferred between the local device 100 and other entities (e.g., remote display 110) in the network 970 using various protocols, such as Asynchronous Transfer Mode (ATM), Frame Relay (FR), Ethernet and so on. To that end, network interface 950-1 comprises conventional interface circuitry that incorporates signal, electrical and mechanical characteristics and interchange circuits needed to interface with the physical media of the network 970 and the various protocols running over that media.

The memory 920-1 is a computer-readable medium implemented as a random access memory (RAM) comprising RAM devices, such as dynamic RAM (DRAM) devices. Memory 920-1 contains various software and data structures used by the processor 930-1 including software and data structures that implement aspects of the present invention.

Memory 920-1 includes an operating system 922-1. The operating system 922-1 is a conventional operating system that comprises software configured to support the execution of processes on processor 930-1. Specifically, operating system 922-1 is configured to perform various conventional operating system functions, such as enabling the processes to be scheduled for execution on the processor 930-1 as well as provide software services and controlled access to resources (e.g., the I/O devices) associated with local device 100.

Remote device 110 is shown in FIG. 9 to include similar components (in an exemplary configuration) as local device 100. In particular, remote device 110 includes memory 920-2, operating system 922-2, program code 960-2, memory bus 925-2, processor 930-2, I/O bus 935-2, network interface 950-2, and I/O interfaces 940-2, corresponding to analogous components in local device 100.

Memory 920-2 includes stored copies of an old image 500 and a new image 502, the old image comprising the last version of the remote display that has been transmitted to the local device and the new image comprising the last version of the remote display that has been transmitted to the local device and updated content from the remote display for a region for which the local device requests an update.

Program code 960-2 includes instructions for: 1) comparing, upon a request from a local device to update a requested region, the requested region in the old and new images (964-1); 2) optionally stripping boundary unchanged pixels which did not change between the old image and the new image to yield a region including on each edge at least one pixel that changed between the old image and the new image (964-2); 3) encoding compared pixels to yield an update region (964-3); and 4) transmitting the update region to the local device (964-4).

While this invention has been particularly shown and described with references to example embodiments thereof, it will be understood by those skilled in the art that various changes in form and details may be made therein without departing from the scope of the invention encompassed by the appended claims.

What is claimed is:

1. A method supporting synchronization of a local display of a local device to a remote display of a remote device, the method comprising:
storing in a computer-readable medium an old image and a new image, the old image comprising the last version of the remote display that has been transmitted to the local device and the new image comprising the last version of the remote display that has been transmitted to the local device and updated content from the remote display for a region for which the local device requests an update;
upon a request from the local device to update a specified requested region at the local display, comparing a portion of the old image corresponding to the requested region and a portion of the new image corresponding to the requested region;
encoding compared pixels to yield an update region, such that
(i) pixels which changed between the old image and the new image are encoded opaque and with the color corresponding to the pixels in the new image, and
(ii) at least one pixel which did not change between the old image and the new image is encoded transparent; and
transmitting the update region to the local device.

2. The method of claim 1, further comprising stripping boundary pixels which did not change between the old image and the new image to yield a region including on each edge at least one pixel that changed between the old image and the new image.

3. The method of claim 1, wherein the steps of storing, comparing, stripping, encoding, and transmitting are performed by the remote device.

4. The method of claim 1, wherein every transparent pixel is encoded with a common color.

5. The method of claim 1, wherein:
pixels that were a first color similar to black in the old image and are also the first color in the new image are encoded with a second color that is different from the first color but visually indistinguishable from the first color; and
pixels which did not change between the old image and the new image are encoded with the first color.

6. The method of claim 1, wherein pixels which did not change between the old image and the new image are encoded with a color value corresponding to a color not found in the portion of the new image corresponding to the requested region.

7. The method of claim 1, wherein pixels that did not change between the old image and the new image are encoded as opaque if the pixels that did not change are part of a sequence of consecutive unchanged pixels shorter than a specified length.

8. The method of claim 7, wherein the specified length is selected from the group of integers ranging from 8 to 32, inclusive.

9. A method supporting synchronization of a local display of a local device with a remote display of a remote device, the method comprising:
requesting over a network an update, to the local display, of a requested region of the remote display;
receiving an update region of the remote display which is a portion of the requested region;
updating at the local device a local representation of the remote display based on the update region.

10. The method of claim 9, further comprising refreshing the local display with a viewed rectangle of the updated local representation, the viewed rectangle corresponding to a portion of the remote display which the user of the local device is currently viewing.

11. The method of claim 9, wherein the steps of requesting, receiving, and updating are performed by the local device.

12. The method of claim 9, wherein priority is given to a viewed rectangle of the local representation corresponding to a portion of the remote display that the user of the local device is currently viewing.

13. The method of claim 12, wherein the requested region is first based on the viewed rectangle and then alternately based on (i) other rectangular regions of the local representation and (ii) the viewed rectangle.

14. The method of claim 13, wherein the other rectangular regions of the local representation are processed in order of distance from the viewed rectangle, from nearest to farthest in concentric layers.

15. The method of claim 9, wherein updating includes updating the local representation from coarser detail to finer detail.

16. The method of claim 9, wherein
at least one Javascript Canvas object is used to store the local representation; and
a Javascript-enabled browser on the local device uses Javascript to display the local representation.

17. The method of claim 9, wherein requesting includes encoding a URL used during requesting with a unique sequence number specifying the requested update.

18. The method of claim 16, further comprising checking a cookie upon receiving the update region and updating the local representation based on the update region and parameters of the cookie.

19. The method of claim 16, wherein the Javascript Canvas object tiles multiple images corresponding to different rectangular regions.

20. The method of claim 16, wherein the update region includes transparent pixels corresponding to pixels that are unchanged since a previous synchronization.

21. The method of claim 18, wherein the parameters of the cookie specify an offset of a corner of the update region relative to a corner of the requested region.

22. An apparatus for sending image data from a first display to a device having a second display over a network and updating the image data of the device, the apparatus comprising:
a computer-readable medium storing an old image and a new image, the old image comprising the last version of the first display that has been transmitted to the device and the new image comprising the last version of the first display that has been transmitted to the device and updated content from the first display for a region for which the device requests an update;
means for comparing, upon a request from the device to update a specified requested region at the second display, a portion of the old image corresponding to the requested region and a portion of the new image corresponding to the requested region;
means for encoding compared pixels to yield an update region, such that
(i) pixels which changed between the old image and the new image are encoded opaque and with the color corresponding to the pixels in the new image, and
(ii) at least one pixel which did not change between the old image and the new image is encoded transparent; and
means for transmitting the update region to the device.

23. The apparatus of claim 22, further comprising means for stripping boundary pixels which did not change between the old image and the new image to yield a region including on each edge at least one pixel that changed between the old image and the new image;

24. The apparatus of claim 22, wherein every transparent pixel is encoded with a common color.

25. The apparatus of claim 22, wherein:
pixels that were a first color similar to black in the old image and are also the first color in the new image are encoded with a second color that is different from the first color but visually indistinguishable from the first color; and
pixels which did not change between the old image and the new image are encoded with the first color.

26. The apparatus of claim 22, wherein pixels which did not change between the old image and the new image are encoded with a color value corresponding to a color not found in the portion of the new image corresponding to the requested region.

27. The apparatus of claim 22, wherein pixels that did not change between the old image and the new image are encoded as opaque if the pixels that did not change are part of a sequence of consecutive unchanged pixels shorter than a specified length.

28. The apparatus of claim 27, wherein the specified length is selected from the group of integers ranging from 8 to 32, inclusive.

29. An apparatus for synchronizing a first display with a second display of a remote device, the apparatus comprising:
means for requesting over a network an update, to the first display, of a requested region of the second display;
means for receiving an update region of the second display which is a portion of the requested region;
a computer-readable medium storing a local representation of the second display;
means for updating the local representation of the second display based on the update region.

30. The apparatus of claim 29, further comprising means for refreshing the first display with a viewed rectangle of the updated local representation, the viewed rectangle corresponding to a portion of the second display which the user of the apparatus is currently viewing.

31. The apparatus of claim 29, wherein priority is given to a viewed rectangle of the local representation corresponding to a portion of the second display that the user of the apparatus is currently viewing.

32. The method of claim 31, wherein the requested region is first based on the viewed rectangle and then alternately based on (i) other rectangular regions of the local representation and (ii) the viewed rectangle.

33. The apparatus of claim 32, wherein the other rectangular regions of the local representation are processed in order of distance from the viewed rectangle, from nearest to farthest in concentric layers.

34. The apparatus of claim 29, wherein the means for updating includes updating the local representation from coarser detail to finer detail.

35. The apparatus of claim 29, further comprising at least one Javascript Canvas object that is used to store the local representation; and
a Javascript-enabled browser that uses Javascript to display the local representation.

36. The apparatus of claim 35, further comprising means for checking a cookie upon receiving the update region and means for updating the local representation based on the update region and parameters of the cookie.

37. The apparatus of claim 35, wherein the Javascript Canvas object tiles multiple images corresponding to different rectangular regions.

38. The apparatus of claim 35, wherein the update region includes transparent pixels corresponding to pixels that are unchanged since a previous synchronization.

39. The apparatus of claim 36, wherein the parameters of the cookie specify an offset of a corner of the update region relative to a corner of the requested region.

40. A computer program product comprising a computer-readable medium having computer-readable program code stored thereon, including program code which, when executed, causes one or more processors to perform the steps of:
storing in a computer-readable medium an old image and a new image, the old image comprising the last version of a first display of a first device that has been transmitted to a second device and the new image comprising the last version of the first display that has been transmitted to the second device and updated content from the first display for a region for which the second device requests an update for a second display of the second device;
upon a request from the second device to update a specified requested region at the second display, comparing a portion of the old image corresponding to the requested region and a portion of the new image corresponding to the requested region;
encoding compared pixels to yield an update region, such that
(i) pixels which changed between the old image and the new image are encoded opaque and with the color corresponding to the pixels in the new image, and
(ii) at least one pixel which did not change between the old image and the new image is encoded transparent; and
transmitting the update region to the second device.

41. The computer program product of claim 40, further including program code which, when executed, causes one or more processors to strip boundary pixels which did not change between the old image and the new image to yield a region including on each edge at least one pixel that changed between the old image and the new image.

42. A computer program product comprising a computer-readable medium having computer-readable program code stored thereon, including program code which, when executed, causes one or more processors to perform the steps of:
requesting over a network an update, to a first display of a first device, of a requested region of a second display of a second device;
receiving an update region of the second display which is a portion of the requested region;
updating at the first device a local representation of the second display based on the update region.
